(19) United States
(12) Patent Application Publication
(10) Pub. No.: US 2011/0147215 A1
(43) Pub. Date: Jun. 23, 2011

(54) METHOD AND DEVICE FOR MANIPULATING AND OBSERVING LIQUID DROPLETS

(75) Inventors: Olivier Fuchs, Grenoble (FR); Fabien Sauter-Starace, Seyssins (FR)

(73) Assignee: COMM.A L'ENER.ATOM.ET AUX ENERGIES ALT., PARIS (FR)

(21) Appl. No.: 13/003,105

(22) PCT Filed: Jul. 9, 2009
(86) PCT No.: PCT/EP09/58777

§ 371 Date: Feb. 16, 2011

(30) Foreign Application Priority Data
Jul. 11, 2008 (FR) 0854745

(51) Int. Cl. B01D 57/02

(52) U.S. Cl. 204/450; 204/600

(57) ABSTRACT

A device for manipulating and observing suspended particles in a liquid. The device includes: a first substrate including at least one first orifice forming an inlet site for the liquid, an observation site for observing the suspended particles, and a mechanism displacing the liquid from the inlet site to the observation site. The first substrate includes a first hydrophobic layer. The liquid is electrically conducting. The liquid can be displaced as a droplet by electrowetting, the droplet being in contact with the hydrophobic layer.

### TECHNICAL FIELD

The present invention relates to the general field of microfluidics and relates to a method and device for manipulating and observing in parallel suspended particles contained in liquid droplets in order to analyze them.

### STATE OF THE PRIOR ART

In the pharmacological field, it is necessary to analyze the effect of a very large number of chemical and biological compounds on biological targets. For example, this may be the study of the action of different drugs or toxins on a type of cell.

The high-throughput screening analysis technique is customarily used since it gives the possibility of conducting a few thousand or even millions of tests in a relatively short time with the purpose of selecting the reagent producing the sought effects.

For this, it is current to use plates with wells, for example including 96, 384 or 1536 wells. With these wells, it is for example possible to put a different reagent in each well in contact with a determined type of cell.

The observation may then be carried out with confocal microscopy which allows observation by fluorescence of the response of the cells to the stimulus caused by the tested reagent.

However, the scanning time of the microscope for locating the cells to be observed is directly related to the volume of the wells and depending on the concentration of the cells may be relatively long, which is contrary to the requirement of rapidity of the high-throughput screening.

Further, the volume of the wells leads to the use of a significant amount of reagent per plate. For example, a plate including 1536 wells, the volume of which is in the order of a few microliters leads to the use of a few milliliters of reagent. The generated cost is then particularly significant because of the large number of tests to be carried out.

Recently, improvements have been undertaken for manipulating and observing small volumes of reagents.

Thus, document US-A1-2007/0243523 describes a device for manipulating and observing suspended particles with the purpose of analyzing them. FIGS. 1A and 1B schematically illustrate the device according to the prior art along a longitudinal section (FIG. 1A) and as a top view (FIG. 1B).

As shown by FIG. 1A, the microfluidic device comprises a substrate A10 in which a microchannel A15 is formed.

A plate with wells A90 lies on an external face of the substrate A10, and comprises at least one inlet well A91 and one outlet well A94, each having an aperture A95 at the bottom of the well. The inlet A91 and outlet A94 wells are connected to each other through the microchannel A15 of the substrate A10.

The inlet well A91 forms a reservoir A91 which may contain suspended particles, for examples cells in solution in liquid toxin. The outlet well A94 may be a discharge reservoir.

A removable cap A130 for pressurization is placed on the inlet A91 and outlet A94 wells for controlling the flow rate in the microchannel A15. For this, a positive or negative pressure is applied at the liquid/air interface in the inlet A91 and outlet A94 wells. A pressure gradient is then generated inside the microchannel A15 which causes the setting into motion of the liquid, and thus of the suspended particles. The cap A130 is connected through flexible hoses A131 to a pressure source (not shown).

The pressure source is controlled by a computer in order to control the value of the generated pressure gradient and therefore the intensity of the flow in the microchannel A15. The liquid may then be set into motion, stopped or displaced according to determined flow rate.

Finally, a portion of the microchannel A15 forms an observation site A100 through which pass the particles to be observed. An observation device (not shown) positioned facing the observation site A100 allows a sequence of images to be made. This observation device may be an optical, fluorescence, phase contrast or further a confocal microscope.

The operation of the device according to the prior art is the following.

By applying a pressure gradient in the microchannel A15, a flow is generated which causes circulation of the suspended particles from the inlet well A91 towards the outlet well A95. When the particles are present in the observation site A100, the flow is stopped in order to allow a sequence of images to be taken by the observation device. Next, the flow is resumed and other suspended particles are introduced into the observation site A100 for taking the next sequence of images.

With the geometry and the size of the microchannel A15 and therefore of the observation site A100 it is possible to reduce the scanning time of the microscope used.

The microfluidic device according to the prior art however has a certain number of drawbacks related to the method for displacing the liquid containing the suspended particles.

On the one hand, the volume of liquid set into motion remains large. It is of the order of the capacity of the inlet well A91, i.e. a few microliters. Indeed, generation of the pressure gradient in the microchannel A15 causes the displacement of the whole of the liquid contained in the inlet well A91.

Further, it is not possible to set into motion a determined amount of liquid, of less than the initial volume of the liquid in the inlet well A91.

On the other hand, the fact that the suspended particles are displaced in a microchannel A15 does not allow control of the displacement of the suspended particles in a localized way. Indeed, by conservation of the flow rate, the displacement of the liquid downstream necessarily has an influence on the liquid located upstream, as well as on the liquid located in inflow channels.

Further, it is not possible to make a complex fluidic network of microchannels, i.e. including a large number of main microchannels and of tributaries. Handling the applied pressure gradient is particularly complicated. Also, the device according to the prior art is limited to a main microchannel without any tributary, or even with very few tributaries.

Moreover, the microchannel A15 may include recirculation areas A16 in which the particles may be trapped. These are notably areas where the walls of the microchannel form a concave edge. The particles may accumulate therein and thereby perturb the flow.

### DISCUSSION OF THE INVENTION

The invention first relates to a method for manipulating and observing suspended particles in a liquid.

According to the invention, the method includes the following steps:
putting a first liquid into contact with a hydrophobic surface,
forming a first droplet from the first liquid and then displacing said droplet by electrowetting in order to bring it onto a observation site, said first droplet being in contact with said hydrophobic surface,
observing the particles contained in said first droplet.

The method may further include, before said step for observing the particles, a step for mixing said first droplet with a second droplet of a second liquid.

The droplet is preferably confined during its displacement between said hydrophobic surface and a substrate positioned facing the hydrophobic surface.

Advantageously, the droplet is formed from an orifice crossing said hydrophobic surface or said substrate, said orifice communicating with a well of a plate with wells.

The volume of the droplet may be comprised between 1 nl and 10 μl.

Said first droplet of liquid preferably comprises cells of different types, or at least one type of cell and one type of toxin.

The particle concentration of said first droplet may be comprised between 50 and 5,000 particles per microliter.

The invention also relates to a device for manipulating and observing suspended particles in a liquid including:
a first substrate comprising at least one first orifice forming an inlet site for said liquid,
an observation site for observing the suspended particles, and
means for displacing liquid from said inlet site to said observation site.

According to the invention, as the first substrate includes a first hydrophobic layer, the liquid being electrically conducting, said means for displacing liquid are adapted so as to displace said liquid as a droplet by electrowetting, said droplet being in contact with said first hydrophobic layer.

Preferably, the first orifice crosses said first substrate in a substantially orthogonal way.

According to an embodiment, the means for displacing said droplet, by electrowetting include:
a plurality of electrodes between said first hydrophobic layer and said first substrate,
a dielectric layer between said first hydrophobic layer and said plurality of electrodes,
at least one counter-electrode in electrical contact with the droplet of liquid, and
a voltage generator for applying a potential difference between the electrodes and said counter-electrode.

Preferably, the device comprises a second substrate positioned facing the first substrate.

The second substrate may be covered with a second hydrophobic layer facing said first hydrophobic layer said counter-electrode being located between said second hydrophobic layer and said second substrate.

According to another embodiment of the invention, the device comprises a second substrate positioned facing the first substrate and covered with a second hydrophobic layer facing said first hydrophobic layer.

The means for displacing said droplet, by electrowetting, advantageously include:
a plurality of electrodes between said second hydrophobic layer and said second substrate,
a dielectric layer between said second hydrophobic layer and said plurality of electrodes,
at least one-counter-electrode in electrical contact with the droplet of liquid,
a voltage generator for applying a potential difference between the electrodes and said counter-electrode.

Said counter-electrode is preferably located between said first hydrophobic layer and first substrate.

Advantageously, said first orifice communicates with a first well positioned on an external face of said first substrate opposite to said first hydrophobic layer.

Advantageously, said first substrate includes at least one second orifice forming an inlet or outlet site for the liquid, said second orifice communicating with the second well placed on an external face of said first substrate opposite to said first hydrophobic layer.

Preferably, said well is a well of a plate with wells.

Preferably, the electrowetting displacement means comprise means for forming a droplet of liquid from said reservoir.

Advantageously, the first substrate and/or the second substrate are made in transparent material.

Advantageously the electrodes are made in a transparent material.

Preferably, the device comprises an observation device for observing the suspended particles contained in said droplet located in the observation site.

Said observation device may comprise a confocal microscope.

Other advantages and features of the invention will become apparent in the non-limiting detailed description below.

### SHORT DESCRIPTION OF THE DRAWINGS

Embodiments of the invention will now be described as non-limiting examples, with reference to the appended drawings wherein:

FIGS. 1A and 1B are schematic illustrations as a longitudinal sectional view (FIG. 1A) or as a top view (FIG. 1B), of a device for manipulating and observing suspended particles in a liquid according to the prior art;

FIGS. 2A-2C illustrate the operating principle for displacing droplets by electrowetting, in an open configuration;

FIG. 3 illustrates the operating principle for displacing liquid by electrowetting, in a device of the closed or confined type which may be applied within the scope of the invention;

FIG. 4 is a schematic illustration as a longitudinal sectional view, of the device according to the preferred embodiment of the invention;

FIG. 5 is a top view of the device illustrated in FIG. 4;

FIGS. 6A-6C illustrate the principle for forming a droplet from a liquid contained in the inlet site of the device according to the invention;

FIGS. 7 and 8 are schematic illustrations, as a top view of an alternative embodiment of the invention;

FIG. 9 is a sectional view of the device according to the alternative embodiment illustrated in FIG. 8 provided with a device for observing the suspended particles.

### DETAILED DISCUSSION OF A PREFERRED EMBODIMENT

A device according to the invention applies a device for displacing liquid, by electrowetting, or more specifically by electrowetting on a dielectric.

In the description which follows, the verbs “cover”, “be located on” and “be positioned on” do not necessarily imply here direct contact. Thus, a material or a liquid may be placed on a wall without there being any direct contact between the material and the wall. An intermediate material may thus be present. The direct contact is achieved when the qualifier “directly” is used with the aforementioned verbs.

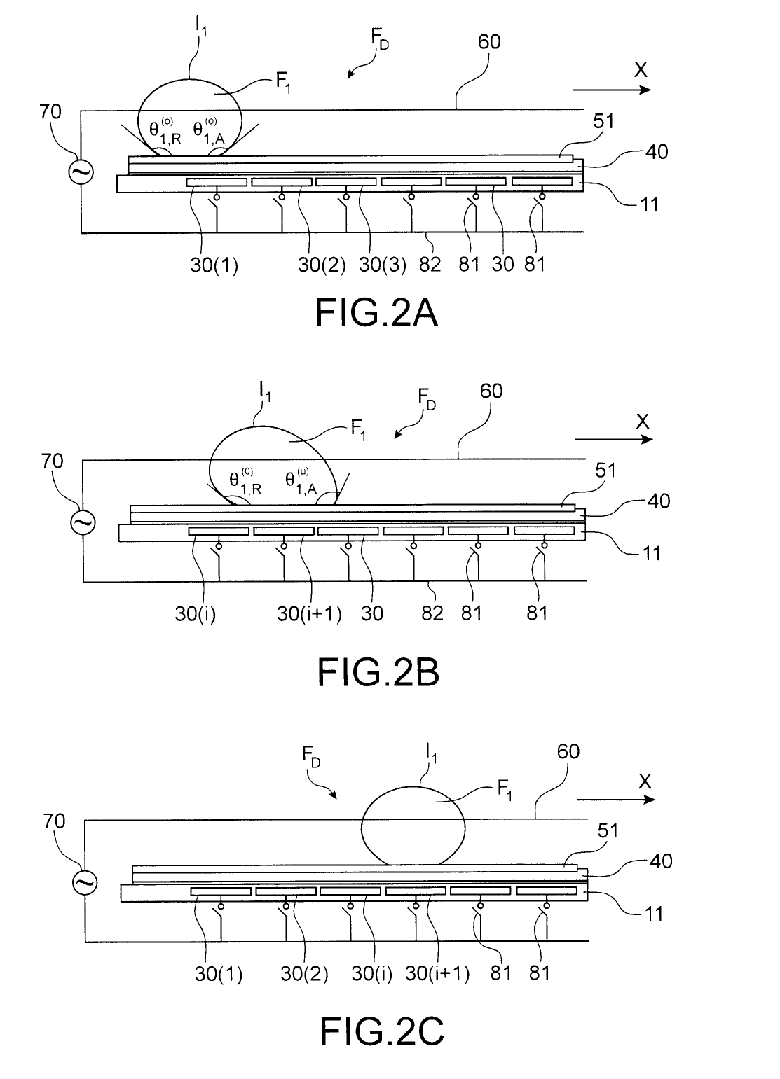

The principle of electrowetting on a dielectric applied within the scope of the invention may be illustrated with FIGS. 2A-2C, within the scope of a device of the open type.

A droplet of an electrically conducting liquid F₁ lies on a network of electrodes 30, from which it is insulated by a dielectric layer 40 and a hydrophobic layer 50 (FIG. 2A). One therefore has a hydrophobic and insulating stack.

The hydrophobicity of this layer means that the droplet has a contact angle on this layer greater than 90°.

It is surrounded by a dielectric fluid F_{d} and forms with this fluid an interface I₁.

The electrodes 30 are themselves formed at the surface of the substrate 11.

A counter-electrode 60, here in the form of a catenary wire, allows electric contact to be maintained with the droplet F₁. This counter-electrode may also be a buried wire or a planar electrode in the cover of a confined system.

The electrode 30 and the counter-electrode 60 are connected to a voltage source 70 with which a voltage U may be applied between the electrodes.

When the electrode 30(1) located in proximity to the droplet F₁ is activated, with switching means 81, the closing of which establishes a contact between this electrode and the voltage source 80 via a common conductor 82, the droplet under voltage F₁/dielectric layer 40 and activated electrode 30(1) assembly acts as a capacitor.

As described by the article of Berge entitled “Electrocapillarité et mouillage de films isolants par l'eau”, (Electrocapillarity and wetting of insulating films with water) C.R. Acad. Sci., 317, Series 2, 1993, 157-163, the contact angle of the interface of the droplet F₁ facing the activated electrode 30(1) then decreases according to the relationship:

$$cos {θ}_{1}^{( U )} = cos {θ}_{1}^{( 0 )} + \frac{1}{2} \frac{{ɛ}_{r}}{e σ} {U}^{2}$$

wherein e is the thickness of the dielectric layer 40, εᵣ is the permittivity of this layer and σ is the surface tension of the interface of the droplet.

In the case of an alternating voltage, the value of the frequency is selected so as to exceed the hydrodynamic response time of the droplet F₁. The response of the droplet F₁ then depends on the RMS value of the voltage, since the contact angle depends on the voltage as U².

According to the article of Bavière et al. entitled “Dynamics of droplet transport induced by electrowetting actuation”, Microfluid Nanofluid, 4, 2008, 287-294, there appears an electrostatic pressure acting on the interface I₁, in proximity to the contact line. If this electrostatic pressure is applied asymmetrically, the droplet F₁ may then be displaced. In FIG. 2A, activation of the electrode 30(1) sets the droplet into motion along the x direction.

The droplet may thus be optionally displaced gradually (FIGS. 2B and 2C) on the hydrophobic surface 50, by successive activation of the electrodes 30(1), 30(2), etc., along the catenary 60.

It is therefore possible to displace liquids, but also to mix them (by having droplets of different liquids brought close to each other), and to perform complex procedures.

Of course, the logic is identical for ensuring the displacement of the droplet in the (−x) direction.

The manipulation of the droplet is located in a plane, the electrodes may indeed be positioned linearly, but also in two-dimensions, thereby defining a plane for displacement of the droplet.

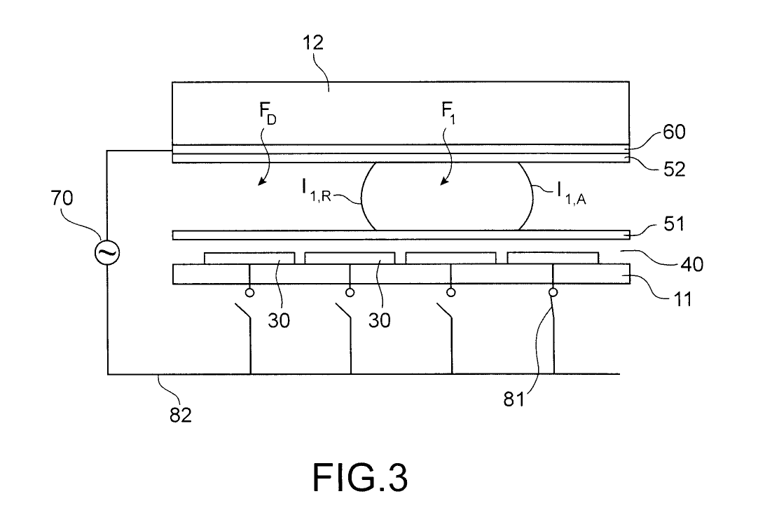

FIG. 3 illustrates the displacement phenomenon of a liquid by electrowetting in a device of the closed or confined type which may be applied within the scope of the invention.

Examples of devices applying this principle are described in the article of Pollack et al. entitled “Electro-wetting-based actuation of droplets for integrated microfluidics”, Lab Chip, 2002, 2, 96-101.

In this figure, the numerical references identical with those of FIGS. 2A-2C designate the same elements.

A droplet of conducting liquid F₁ is confined between a lower substrate 11 containing the plurality of control electrodes 30, and an upper substrate 12 positioned facing the lower substrate 11.

The droplet F₁ includes an upstream interface I_{1,R} and a downstream interface I_{1,A}.

A hydrophobic layer 52 preferably covers the upper substrate 12.

The counter-electrode 60 here is a planar electrode positioned between the hydrophobic layer 52 and the upper substrate 12. It may be a catanary wire like in FIGS. 2A-2C, or a buried wire.

The operating principle in this type of device is similar to the one which was described earlier. The triple line of the upstream I_{1,R} and downstream I_{1,A} interfaces is set into motion by successive activation of the control electrodes 30, causing a global movement of the droplet in the x or (−x) direction.

It should be noted that the fluid F_{D} does not undergo any global movement in the displacement direction of the droplet. In other words, the fluid F_{D} is not “pushed” by the droplet F₁, as this would be the case in a microchannel, but circumvents the droplet which moves.

It should also be noted that the electrodes 30 and the dielectric layer 40 may alternatively be located between the hydrophobic layer 52 and the upper substrate 12. The counter-electrode 60 then being located under the hydrophobic layer 51 of the lower substrate 11.

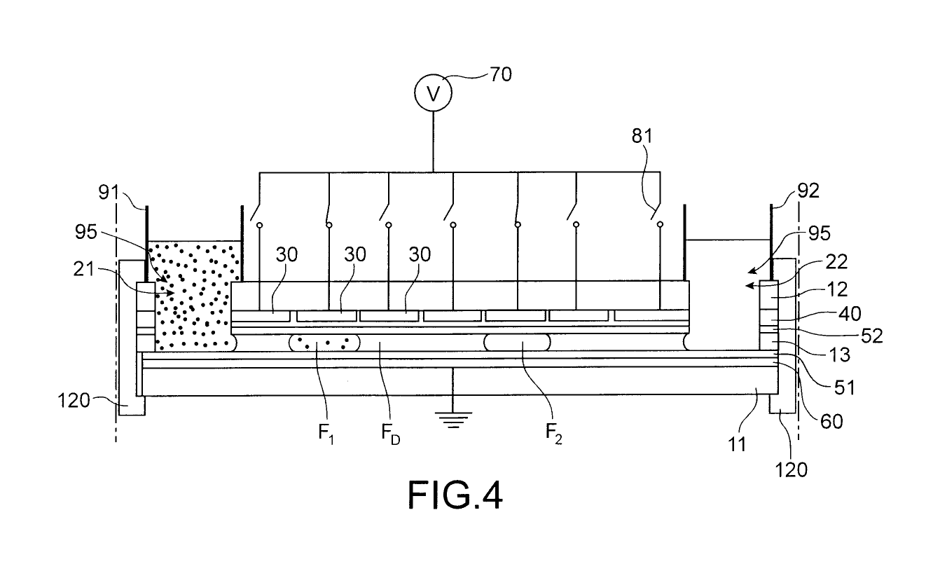

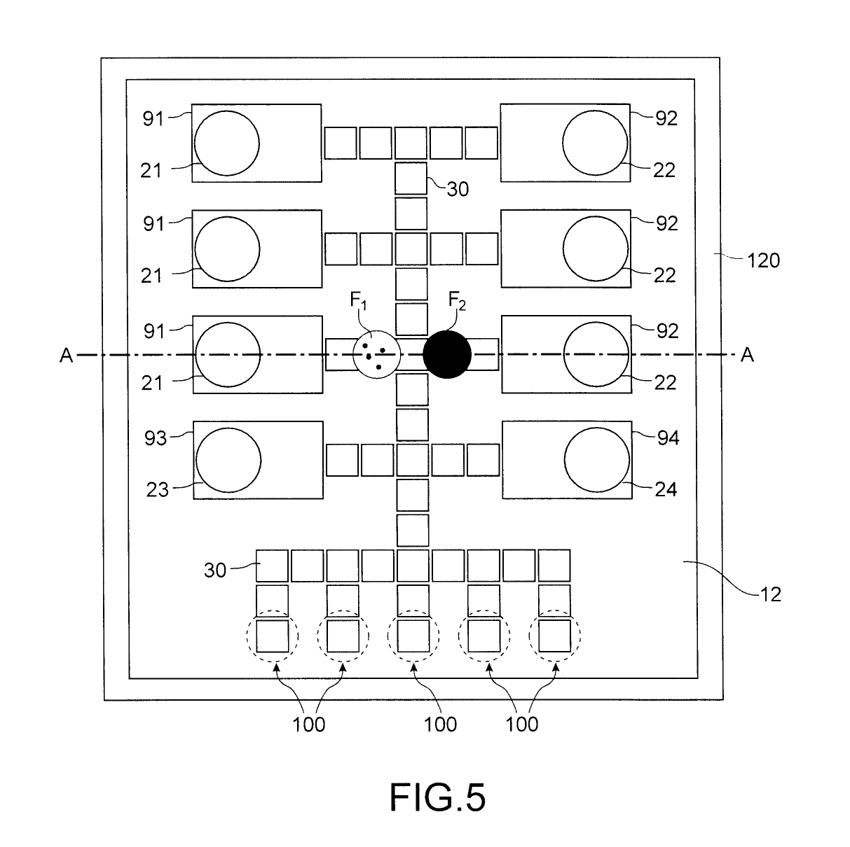

The preferred embodiment of the invention is illustrated in FIGS. 4 and 5 which show, as a longitudinal sectional view (FIG. 4) and as a top view (FIG. 5), a microfluidic device for manipulating and observing suspended particles in a droplet of liquid.

The sectional view of FIG. 4 is achieved along the A-A plane illustrated in FIG. 5.

In these figures, the numerical references identical with those of FIG. 3 designate the same elements.

With reference to FIG. 4, the device includes a lower substrate 11 and an upper substrate 12, positioned facing each other.

Both substrates 11 and 12 are mounted to each other via a spacing shim 13 which allows the gap between the substrate 11, 12 to be maintained constant. The shim 13 extends along the periphery of each substrate 11, 12.

The upper substrate 12 advantageously includes a plurality of orifices, 22, 23, and 24 (FIG. 5) forming liquid inlet or outlet sites, crossing the substrate 12 substantially perpendicularly (FIG. 4).

For example, the substrate 12 includes at least one orifice 21 forming a liquid inlet and storage site containing particles to be observed, at least one orifice 22 forming an active agent inlet site. The term “active agent” is used for designating for example a toxin or a drug. Substrate 12 may also include at least one orifice 23 forming an inlet site for buffer liquid in order to control the concentration of particles in the droplets, and for example an orifice 24 forming an outlet or discharge site.

The orifices 21, 22, 23 and 24 may communicate with wells which contain the corresponding liquids, 91, 92, 93 and 94 respectively (FIG. 5): located against the external face of the upper substrate 12 opposite to the hydrophobic layer 52. Fluidic communication is ensured via an aperture 95 positioned at the bottom of the well. The orifices 21, 22, 23, 24 may thereby form reservoirs.

The wells 91, 92, 93 and 94 are advantageously wells of a plate with wells (8, 96, 384, 1586 wells) and may be integrated to the device according to the invention. The substrates 11 and 12 may be attached at their periphery to the peripheral wall 120 of the plate with wells, which extends perpendicularly to the plane of the substrate, in order to ensure a firm assembly between the orifices and the wells.

Advantageously, a same well may communicate with several orifices. In this case, the well then has volume and suitable geometry. It includes a plurality of apertures 95, each being positioned facing the corresponding orifice.

In this embodiment, the plurality of control electrodes 30 and the dielectric layer 40 are located between the hydrophobic layer 52 and their upper substrate 12. More specifically, the plurality of electrodes 30 are in contact with the upper substrate 12 and the dielectric layer 40 covers these electrodes.

As shown in FIG. 5, the electrodes 30 are positioned so as to form a two-dimensional network. With this network of electrodes 30, it is possible to gradually displace the droplets of liquid on a plane, to mix them, and bring them onto an observation site 100 in order to observe the particles they contain.

FIG. 4 shows the counter-electrode 60 incorporated under the hydrophobic layer 51 of the lower substrate 11. It may have a two-dimensional structure so as to ensure electrical contact with the moving droplets. It may also be formed by a two-dimensional assembly of catenary wires.

The voltage source 70, preferably an alternating voltage source, is connected to the electrodes 30 and to the counter-electrodes 60. The frequency is advantageously comprised between 100 Hz and 10 kHz, preferably of the order of 1 kHz, so as to exceed the hydrodynamic response time of the droplets of liquid. The ions possibly contained in the liquid then do not have the time to migrate and to accumulate, according to their charge, in the proximity of the activated electrode 30.

Thus, the response of the droplets depends on the time average of the applied voltage, or more specifically on the RMS value of the latter since the contact angle depends on the voltage as U², according to the relationship given earlier. The RMS value may vary between 0V and a few hundred volts, for example 200V. Preferably, it is of the order of a few tens of volts.

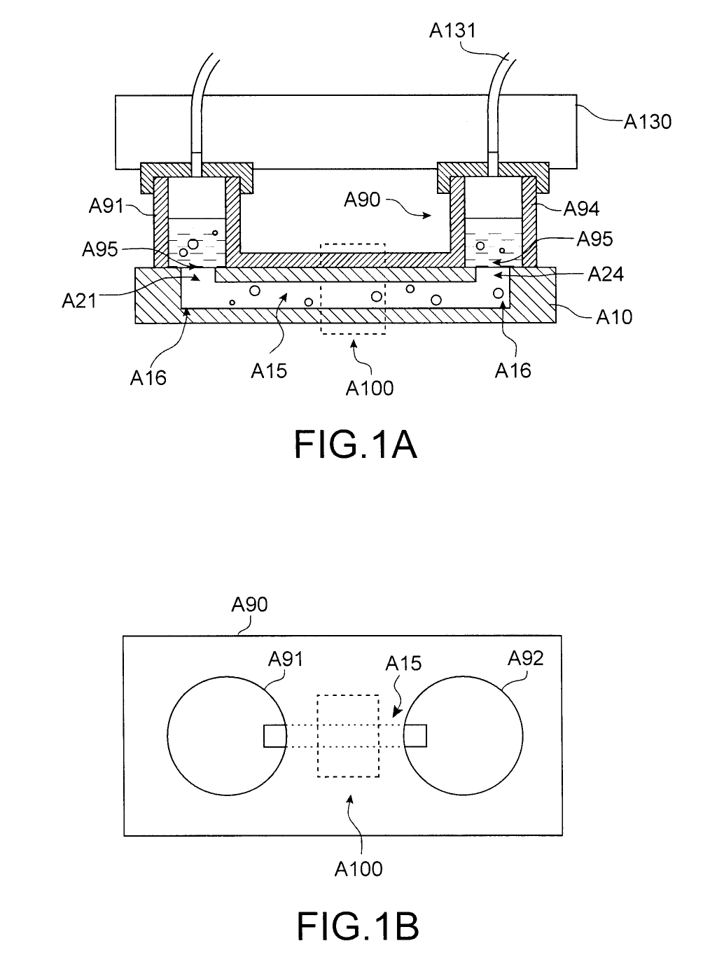

Means give the possibility of controlling or activating the electrodes 30, for example a PC type computer and a system of relays connected to the device or to the chip, such as relays 81 of FIG. 1A, these relays being driven by means of the PC type.

According to an alternative embodiment, the dielectric layer 40 and the electrode 30 may be positioned under the hydrophobic layer 51 of the lower substrate 11, as explained earlier, the counter-electrode 60 may then be located between the hydrophobic layer 52 and the upper substrate 12.

In the whole of the description, it will be stated that the formed droplet may be displaced “on” the displacement plane formed by the network of electrodes 30, whether these electrodes are located at the lower 11 or upper 12 substrate.

FIG. 4 shows a droplet of liquid F₁ containing particles to be observed in proximity to an orifice 21, and a second droplet of liquid F₂ in proximity to a second orifice 22. The second droplet then contains an active agent.

The particles to be observed are preferably biological cells. The particle concentration may be comprised between 50 and 5,000 particles per microliter, and preferably is about 500 particles per microliter.

The droplets are surrounded with a dielectric fluid F_{D}, which is non-miscible with the liquids of droplets F₁ and F₂. The fluid F_{D} may be air, a mineral or silicone oil, a perfluorinated solvent, such as FC-40 or FC-70, or further an alkane such as undecane.

Each droplet may have a volume comprised between 0.1 and 100 nanoliters, and preferably is 0.2, 2, 8 or 64 nl.

The droplets may therefore be displaced on the two-dimensional network of electrodes 30 as far as an observation site 100. A plurality of observation sites 100 may be provided in the network of electrodes 30.

The observation site 100 is an area of the device according to the invention through which it is possible to observe the contents of the droplet which is located therein.

The observation may be carried out through the lower substrate 11. For this, the materials of the lower substrate 11, of the hydrophobic layer 51 and of the counter-electrode 60 are preferably transparent.

Alternatively it may be carried out through the upper substrate 12. For this, the materials of the upper substrate 12, of the hydrophobic layer 52 and of the electrode 30 located in the observation site are preferably transparent.

It is advantageous if the materials of the whole of the components which have been mentioned are transparent, in order to allow observation through the upper 12 or lower 11 substrate, depending on the choice of the user or on the constraints of the environment.

The observation device may comprise an optical microscope of the direct light, phase contrast or fluorescence type or further of the near field type. It may also be a confocal or digital tomography microscope or a digital holographic microscopy device.

It may also comprise a unit for managing snapshots and storage of data, of the PC type in order to subsequently post-process and analyze the sequences of the taken images.

As this has just been stated, the substrates 11 and 12 are preferably made in a transparent material, for example in glass or in polycarbonate.

The spacing shim 13 may preferentially be made in a photo-imageable dry film of the Ordyl type, which allows accurate control of the gap between the lower 11 and upper 12 substrates. The spacing between the lower substrate 11 and the upper substrate 12 is typically comprised between 10 μm and 500 μm, and preferably between 50 μm and 100 μm.

The orifices 21, 22, 23 and 24 have a diameter of a few micrometers, for example comprised between 50 μm and a few millimeters. These orifices are for example made by lithography and selective etching. Depending on the diameters and on the depth to be etched, dry etching (etching by gases, for example SF₆, in a plasma) may be used. The etching may also be wet etching. For glass (in majority SiO₂) or silicone nitrides, it is possible to use etchings with hydrofluoric acid or phosphoric acid (these etchings are selective but isotropic). The etching may be carried out by laser ablation or further with ultrasound. Micromachining may also be used in particular for polycarbonate.

These orifices may be in fluidic communication with the wells of the plate with wells, the capacity of each well may be comprised between 1 μl and 1 ml.

The electrodes 30 and counter-electrodes 60 are made by depositing a transparent material, for example ITO, on the substrate. This conducting layer may be sprayed on or made in a sol-gel process. It is then etched according to a suitable pattern, for example by wet etching.

The thickness of the electrodes is comprised between 10 nm and 1 μm, preferably 300 nm. The electrodes 30 are preferably square with a side, the length of which is comprised between a few micrometers to a few millimeters, preferably between 50 μm and 1 mm. The surface area of the electrodes 30 depends on the size of the droplets to be transported. The spacing between neighboring electrodes may be comprised between 1 μm and 10 μm.

The dielectric layer 40 is made by depositing a layer of silicone nitride Si₃N₄, with a thickness generally comprised between 100 nm and 1 μm, preferably 300 nm. A plasma enhanced chemical vapor deposition (PECVD) method is preferred over a low pressure chemical vapor deposition (LPCVD) method for thermal reasons. Indeed, the temperature of the substrate is only raised to a temperature between 150° C. and 350° C. (depending on the sought properties) against about 750° C. for PCVD deposition.

The hydrophobic layers 51 and 52 are obtained by depositing a Teflon or SiOC, or parylene layer by evaporation in vacuo, on the lower 11 and upper 12 substrates. With this layer it is notably possible to reduce or even avoid the hysteresis effects of the wetting angle. Its thickness, generally comprised between 100 nm and 5 μm, is preferably 1 μm.

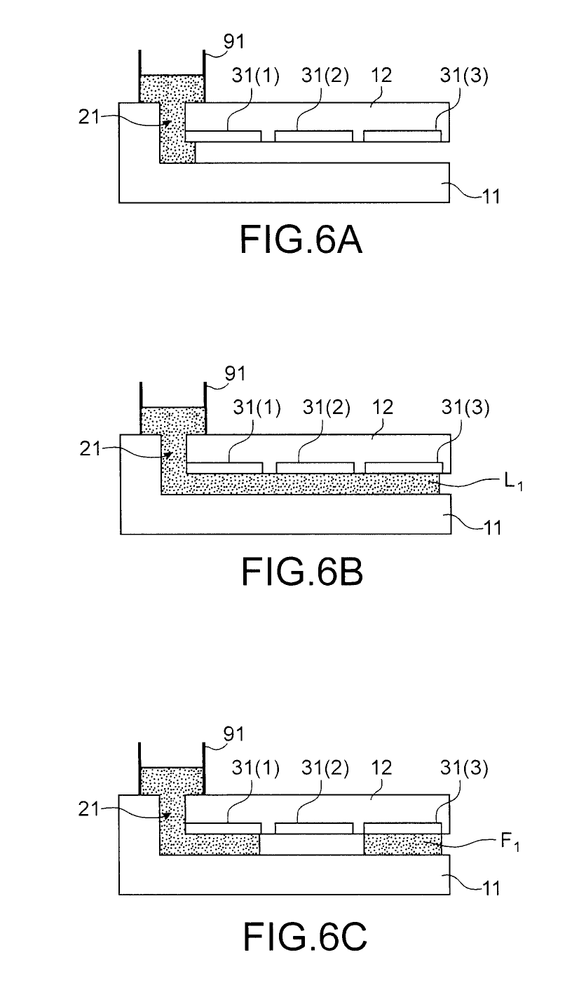

FIGS. 6A and 6C show how a droplet may be formed from a well, 91, 92, 93 or 94, here from well 91.

The device according to the invention is shown here very schematically. Certain components do not appear, in order to simplify the figures.

A liquid to be dispensed is introduced into the orifice 21 forming an inlet site from the well 91 (FIG. 6A). Each orifice then forms a reservoir.

The lower and upper substrates, illustrated schematically in FIGS. 6A-6c, are for example similar to the structure of FIG. 4.

Three electrodes 31(1), 31(2), 31(3), similar to the electrodes 30 for displacing droplets of liquid, are illustrated in FIGS. 6A-6C.

Simultaneous activation of this series of electrodes 31(1), 31(2), 31(3) leads to spreading of the liquid from the inlet site 21, and therefore to a liquid segment L1 as illustrated in FIG. 6B.

Next, this liquid segment is cut by deactivating the electrode 31(2). A droplet F₁ is thereby obtained, as illustrated in FIG. 6C.

A series of electrodes 31(1), 31(2), 31(3) is therefore used for drawing the liquid from the well 91 through the inlet site 21 into a liquid segment L₁ (FIGS. 6A and 6B) and for then cutting this liquid segment L₁ (FIG. 6C) and forming a droplet F₁ which will be able to be displaced on the displacement plane, as described above.

The operation of the device according to the invention is the following, with reference to FIGS. 4 and 5.

A droplet F₁ containing suspended particles is formed from the well 91. By successive activation of the electrodes 30, it is displaced on the two-dimensional network of electrodes 30.

One or more droplets F₂ containing an active agent may be formed and displaced as far as the droplet F1, in a mixing site, so as to put the suspended particles in contact with the intended active agent.

The droplets F₂ may also contain a buffer liquid, in order to control the concentration of particles in the droplet F₁.

The droplet F₁ is then displaced as far as the observation site 100 in order to carry out sequences of images of the particles. The response of the particles to the stimulus caused by the active agent may thus be observed.

Next, the droplet F₁ is displaced as far as the outlet site 24 and discharged into the discharge well 94.

It should be noted that several droplets F₁ may be formed from a single well 91 opening out onto several orifices and displaced simultaneously on the two-dimensional network without the displacement of one of them having an influence on the displacement of the other ones.

It is then advantageous if a plurality of observation sites 100 is provided for allowing observation of the different droplets F₁, as shown in FIG. 5. The observation device is then mobile in the reference system bound to the substrates so as to come and face each observation site 100 when a droplet F₁ is located therein.

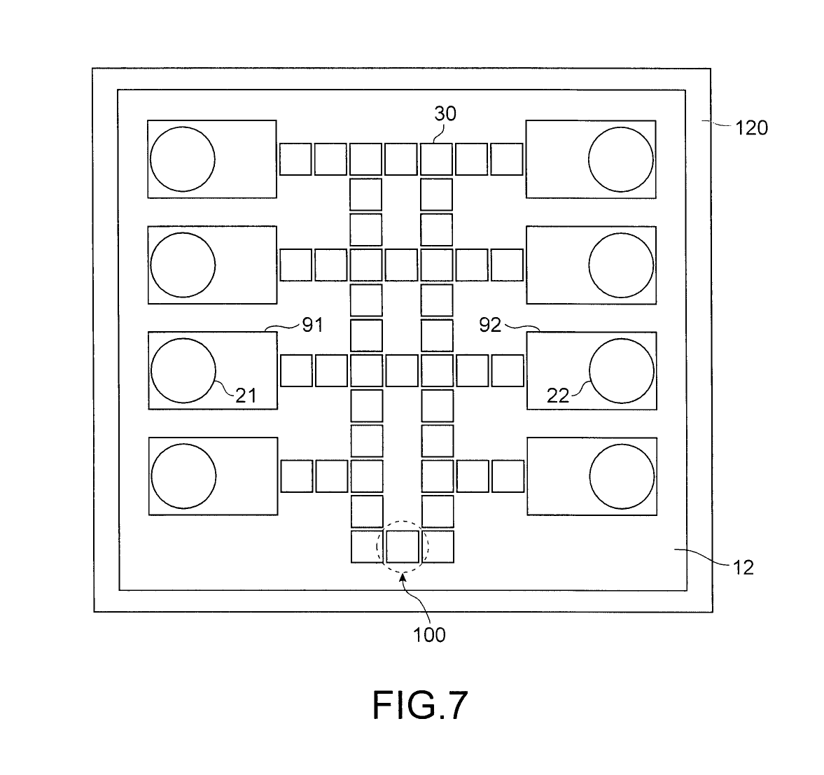

FIG. 7 shows an alternative embodiment in which a single observation site is provided. The network of electrodes 30 is then designed so that the droplets F₁, once they are observed, may continue their displacement in the same direction. A train of droplets F₁ may then be formed and displaced over a same path. The observation device is then attached to the device, facing the observation site.

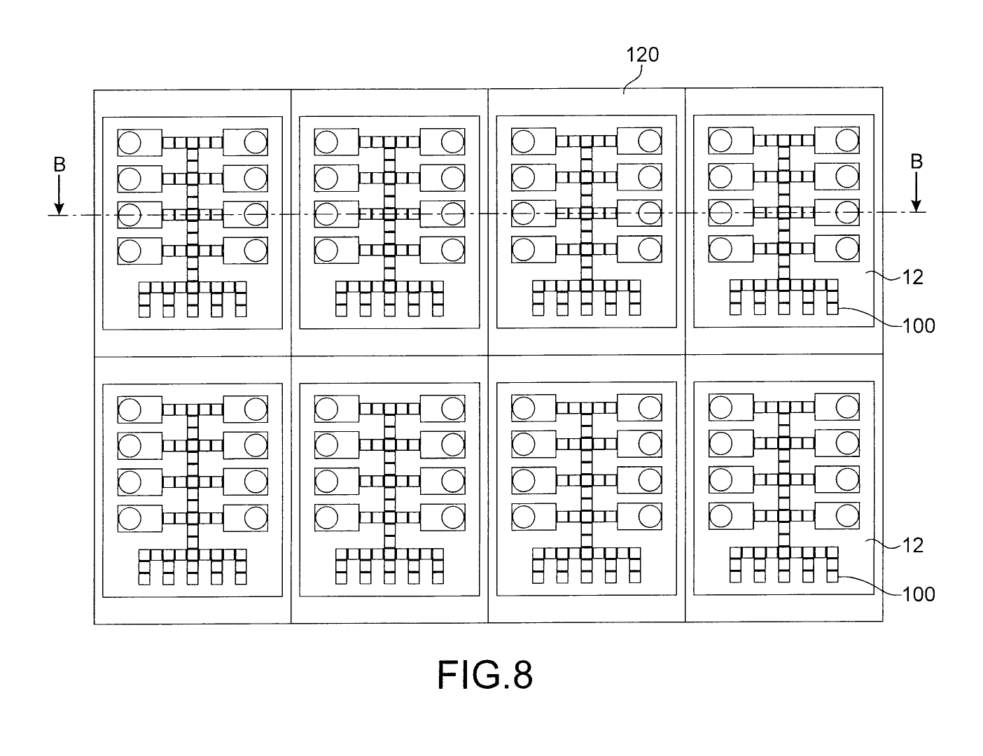

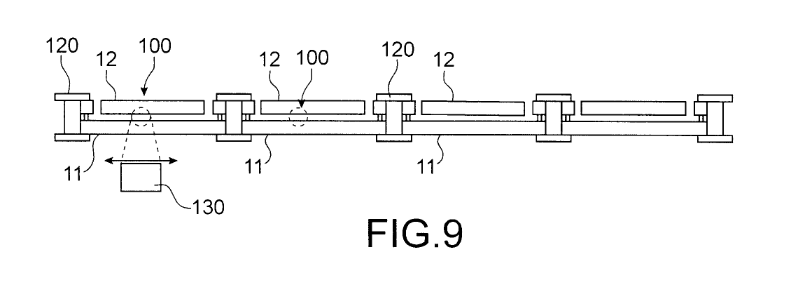

According to another alternative embodiment of the invention illustrated in FIGS. 8 and 9, a plurality of devices according to the invention may be mounted on a single well with plates. Each device according to the invention is independent of the neighboring devices (FIG. 8). The observation device 130 then moves so as to be positioned facing the different observation sites 100 of the different devices according to the invention (FIG. 9).

The invention provides multiple advantages.

It first allows the use of extremely reduced volumes of liquid droplets of the order of 1 nanoliter (for example between 0.1 nl and 100 nl, preferably 2 nl, 8 nl or 64 nl), without any dead space, and allows control of the concentrations.

The invention allows single dispensing from a reservoir, of drugs and of cells, or of any active agent, instead of dispensing well by well as in the device of the prior art described earlier.

The cost related to the use of the cells and of the reagents is then particularly reduced as compared with that of the device according to the prior art.

Further, the scanning time of the microscope for locating the particles contained in the droplet is also significantly reduced. The device according to the invention meets the rapidity requirements of high-throughput screening.

Further, there is no evaporation which would risk having an influence on the viability of the cells.

The concentration may be controlled by the successive dilutions from a reservoir with a known concentration.

It is then possible to investigate the combined actions of mixtures of toxins, in order to check whether their actions are compatible and/or synergistic or not.

It is also possible to locally control the displacement of the droplets, independently of the droplets located upstream and downstream. A complex network of droplet travel paths may therefore be easily made.

There is no recirculation area which may trap the suspended particles. Indeed, the latter remain contained in the moving droplet.

1-19. (canceled)

20. A method for manipulating and observing suspended particles in a liquid, comprising:
putting a first liquid into contact with a hydrophobic surface;
forming a first droplet from the first liquid and then moving the droplet by electrowetting to bring the droplet onto an observation site, the first droplet being in contact with the hydrophobic surface;
observing the particles contained in the first droplet;
the droplet being confined during its displacement between the hydrophobic surface and a substrate positioned facing the hydrophobic surface, and formed from an orifice crossing the hydrophobic surface or the substrate, the orifice communicating with a well of a plate with wells.

21. The method according to claim 20, further comprising, before the observing the particles, mixing the first droplet with a second droplet of a second liquid.

22. The method according to claim 21, wherein the droplets have a volume between 0.1 nl and 10 μl.

23. The method according to claim 20, wherein the first liquid droplet comprises cells of different types, or of at least one type of cell and one type of toxin.

24. The method according to claim 20, wherein the particle concentration is between 50 and 5,000 particles per microliter.

25. A device for manipulating and observing suspended particles in a liquid, comprising:
a first substrate including at least one first orifice forming an inlet site for the liquid;
an observation site for observing the suspended particles; and
means for displacing the liquid from the inlet site to the observation site,
wherein the first substrate includes an first hydrophobic layer, the liquid being electrically conducting, and the means for displacing the liquid is configured to displace the liquid as a droplet by electrowetting, the droplet being in contact with the first hydrophobic layer;
wherein the first orifice communicates with a first well positioned on an external face of the first substrate opposite to the first hydrophobic layer; and
the first well is a well of a plate with wells.

26. The device according to claim 25, wherein the means for displacing the droplet, by electrowetting, includes:
a plurality of electrodes between the first hydrophobic layer and the first substrate,
a dielectric layer between the first hydrophobic layer and the plurality of electrodes,
at least one counter-electrode in electrical contact with the liquid droplet, and
a voltage generator to apply a potential difference between the electrodes and the counter-electrode.

27. The device according to claim 26, further comprising a second substrate positioned facing the first substrate.

28. The device according to claim 27, wherein the second substrate is covered with a second hydrophobic layer facing the first hydrophobic layer, the counter-electrode being located between the second hydrophobic layer and the second substrate.

29. The device according to claim 25, further comprising a second substrate positioned facing the first substrate and covered with a second hydrophobic layer facing the first hydrophobic layer.

30. The device according to claim 29, wherein the means for displacing the drop, by electrowetting, includes:
a plurality of electrodes between the second hydrophobic layer and the second substrate,
a dielectric layer between the second hydrophobic layer and the plurality of electrodes,
at least one counter-electrode in electrical contact with the droplet of liquid, and
a voltage generator to apply a potential difference between the electrodes and the counter-electrode.

31. The device according to claim 30, wherein the counter-electrode is located between the first hydrophobic layer and the first substrate.

32. The device according to claim 27, wherein the first substrate includes at least one second orifice forming an inlet or outlet site for the liquid, the second orifice communicating with a second well positioned on an external face of the first substrate opposite to the first hydrophobic layer.

33. The device according to claim 32, wherein the second well is a well of a plate with wells.

34. The device according to claim 27, wherein the displacement means by electrowetting comprises means to form a droplet of liquid from the orifice.

35. The device according to claim 27, wherein the first substrate and/or the second substrate are made in a transparent material.

36. The device according to claim 35, wherein the electrodes are made in a transparent material.

37. The device according to claim 25, further comprising an observation device for observing suspended particles contained in the droplets located in the observation site.

38. The device according to claim 37, wherein the observation device comprises a confocal microscope.
